(19) United States
(12) Patent Application Publication
(10) Pub. No.: US 2006/0260360 A1
(43) Pub. Date: Nov. 23, 2006

(54) Method and apparatus for manufacturing internally coated glass tubes

(76) Inventors: Erhard Dick, Pechbrunn (DE); Erich Fischer, Mitterteich (DE); Roland Fuchs, Leonberg (DE); Alexander Hummer, Arzberg (DE); Stephan Tratzky, Neustadt (DE)

Correspondence Address: STRIKER, STRIKER & STENBY, 103 EAST NECK ROAD, HUNTINGTON, NY, 11743, US

(21) Appl. No.: 11/430,818

(22) Filed: May 9, 2006

(30) Foreign Application Priority Data
May 18, 2005 (DE) 10 2005 023 582.4

(51) Int. Cl. C03C 17/00; C03B 15/14; C03B 17/04; C03B 15/18

(52) U.S. Cl. 65/60.53; 65/86; 65/187

(57) ABSTRACT

The invention relates to a method for manufacturing a glass tube with a coated inner surface by drawing a glass melt (5) to a bag (8) of softened glass and hot forming to a glass tube (9). During the process a substance is introduced into the bag (8) of softened glass. According to the invention the substance is introduced as an aerosol and the inner surface is coated by means of the substance during the hot forming. The method permits economical internal coating with a continuous glass drawing method. The use of aggressive chemical substances for internal coating can be dispensed with according to the invention. As a result, for example, internally coated glass tubes with improved hydrolytic resistance can be manufactured. The invention also relates to a suitable apparatus for manufacturing internally coated glass tubes and the use of glass tubes manufactured by this means for further processing to a hollow, internally coated formed glass body, for example, as primary packaging in the pharmaceuticals field.

### FIELD OF THE INVENTION

The present invention relates in general to the manufacturing of glass tubes having an internally coated inner surface, particularly a chemically or physically modified inner surface, by means of a continuous or semi-continuous glass drawing method. The present invention also relates to the use of such glass tubes as semi-finished products for manufacturing hollow formed glass bodies by further forming the semi-finished product into hollow formed glass bodies.

### BACKGROUND OF THE INVENTION

Technical applications for glass, for example as a starting material for primary packaging materials in the pharmaceuticals industry, increasingly demand hollow formed glass bodies whose inner surface is as chemically inert as possible in that, for example, it releases as few ions as possible into a substance stored within it or reacts as little as possible with a substance stored in the formed glass body. Glasses with inert surfaces can be prepared by suitable choice of the glass composition. However, the manufacturing of such glasses is frequently relatively expensive. Furthermore, such glass types are often not able to comply with the required specifications, particularly with regard to their formability into hollow bodies at the lowest possible temperatures.

Alternatively, it is known from the prior art to modify chemically the inner surface of glass tubes made as semi-finished products for forming into hollow formed glass bodies, for example by targeted sodium depletion of the glass surface or to modify it physically, for example by applying a suitably inert coating onto the inner surface. This type of chemical or physical modification of the inner surface can also essentially be carried out on the already formed hollow formed glass body. Methods of this type, however, are subject to numerous limitations. The cost for suitable modification of the inner surface is therefore shifted onto the manufacturer of the hollow formed glass body, which is frequently undesirable for reasons of cost and suitability. For many applications, it is more appropriate to make hollow formed glass bodies by forming a glass tube which has a suitably inert inner surface. The inner surface may, under certain circumstances, become more reactive again on forming of the glass tube into the hollow formed glass body, but the reactivity of the inner surface achievable with hollow formed glass bodies made by this means may nevertheless be adequate for the desired technical application. The present invention is therefore aimed at economical manufacturing of glass tubes with suitably modified inner surfaces.

During the manufacturing of glass tubes, a distinction is made in principle between continuous or semi-continuous manufacturing methods on the one hand and discontinuous manufacturing methods on the other hand. Due to the usually fundamentally different manufacturing parameters, the principles applied to discontinuous manufacturing methods cannot be transferred to continuous manufacturing methods, or cannot be transferred without further effort, so that they do not offer any inspiration to persons skilled in the art for improving continuous or semi-continuous manufacturing methods.

U.S. Pat. No. 4,175,941 and U.S. Pat. No. 4,228,206 disclose a continuous method for manufacturing internally coated glass tubes using the Vello method (see U.S. Pat. No. 2,009,793). In this method, the glass tube is formed, by drawing of a glass melt over a forming body, into a bag of softened glass (also known as a bulb) and, by hot forming, into the glass tube. The inner profile of the glass tube is determined in the usual manner by the profile of the forming body and by other process parameters, such as the temperature and viscosity of the glass melt, the size of the annular gap at the outlet of the melt tank, and the glass drawing speed. For internal coating, an aqueous solution containing tin chloride and hydrogen fluoride is introduced into the bag which is at temperatures above the softening point of the glass. By reacting with the hot inner surface, the solution forms a conductive tin oxide layer. The chemicals used are relatively aggressive. Later release of residues of these compounds, for example as a gas or by being dissolved, cannot be ruled out. This is unacceptable for many technical applications, particularly in the pharmaceutical industry.

EP 0 501 562 E1 discloses a continuous method for manufacturing an internally coated glass tube by the Vello method. With this method, a gas or a gas mixture which does not react chemically at the drawing temperature of the glass is introduced into the bag of softened glass. Rather, in a region where the glass has cooled to a temperature below its softening temperature, the gas or gas mixture in the glass tube is ignited to a plasma, from which a coating of SiO₂ is deposited on the internal surface of the cooled glass tube. When operating this method, a gas mixture of silicon tetrafluoride, oxygen and nitrogen is used. The method is also applicable to the manufacturing of glass tubes using the known Danner method.

U.S. Pat. No. 4,717,607 discloses a continuous method for manufacturing glass tubes with a modified inner surface, specifically with targeted sodium depletion of the inner surface. In this method, an organic fluorine-containing gas (preferably 1,1-difluoroethane) is blown under excess pressure into the bag of softened glass. The gas is ignited in the presence of oxygen. The fluoride gas produced reacts with alkali ions on the hot inner surface to produce gaseous fluorine-alkali compounds that do not condense on the surface, but are blown out of the interior of the tube by the excess pressure. With this method, also, aggressive substances have to be used, and this is undesirable for the reasons given above.

DE 100 45 923 C2 discloses a method for manufacturing internally coated glass tubes, wherein the glass melt is drawn over a coated drawing die which leads, during the drawing procedure, by suitable diffusion and solution processes, to an appropriate modification of the inner surface of the glass tube. However, the coating on the drawing die becomes used up in the course of time, resulting in stoppages while the die is changed, which are time-consuming and costly.

DE 198 01 861 A1 discloses a method for manufacturing an internally coated glass tube. The cooled glass tube is clamped in a device and filled with a gas in which plasma is generated, from which a coating is deposited onto the inner surface of the glass tube. This method is not suitable for continuous manufacturing of internally coated glass tubes. EP 0005 963 B1 discloses a comparable method wherein vapours are fed into the tube and then an inductively excited high frequency plasma is ignited and maintained in the tube.

Methods for coating float glass are also known from the prior art. Due to the fundamentally different geometrical conditions and process parameters, the principles applied to this different technical field are not transferable, or not without difficulty, to the internal coating of glass tubes in a continuous glass drawing process, so that they do not offer any inspiration to persons skilled in the art for improving such processes.

DE 42 37 921 A1 discloses a method for modifying the surface activity of a silicate glass substrate, wherein a silicon-containing coating is applied as an SiOₓ coating by pyrolytic decomposition of silicon-containing organic substances.

U.S. Pat. No. 4,731,256 discloses a method for coating a flat glass substrate with a tin oxide coating doped with fluorine. The coating is deposited using a CVD method.

WO 98/06675 discloses a method for depositing an oxide layer on a float glass. A precursor gas mixture containing a metal tetrachloride and organic oxygen is introduced into a coating chamber which opens towards the passing hot float glass. The precursor gas mixture is heated by the hot glass surface, bringing about a CVD coating.

WO 00/75087 A1 discloses a similar coating method.

### SUMMARY OF THE INVENTION

It is an object of the present invention to provide a method and a device with which internally coated glass tubes can be manufactured easily and economically. A further aspect of the present invention concerns the use of an internally coated glass tube made by this method for further processing into a hollow, internally coated formed glass body.

In a method according to the present invention, the glass tube is formed by drawing of a glass melt into a bag of softened glass and by hot forming into said glass tube. The melt may be drawn over a central forming body which determines the profile of the glass tube, by means of known drawing methods, in particular the Vello method, the Danner method, the down-draw method, or any other desired glass drawing method. When the melt is drawn out, a bag of softened glass is firstly formed and this is drawn out to a glass tube in a further hot forming process. The hot forming typically takes place without any external application of force, although this is not ruled out in accordance with other embodiments of the present invention. With this method, a substance is additionally introduced or dumped into the bag of softened glass by means of which the inner surface is coated, that is physically or chemically modified, as will be described in the following.

According to the invention, the substance is introduced or dumped as a dispersion and the inner surface is coated by the substance or a decomposition or reaction product during the hot forming. According to the invention, the dispersion may be present in the form of a suspension or as an aerosol, that is, in the form of finely dispersed solid particles in a liquid or a gas. Also conceivable is use of a suspension. In any event, the substance has a large surface area when introduced and this favours and accelerates reactions with the hot inner surface during hot forming, for example chemical reactions, or deposition, as will be described in greater detail below. According to the invention, the very finely dispersed state of the liquid or solid particles also enables even coating of the whole inner surface of the glass tube. A further advantage is that the method according to the invention can be carried out continuously or semi-continuously, so that the glass tube can be drawn off continuously or semi-continuously.

Depending on the type of substance introduced and on the respective process parameters, a variety of different processes can be effected, to produce the desired internal coating of the glass tube. For example, by means of the dispersion, targeted depletion of ions in the internal surface can be brought about, in particular a targeted sodium depletion. Or by means of the dispersion, a targeted internal coating of the glass tube can be brought about, for example for increasing the hydrolytic resistance, as will be described in the following. The term ‘internal coating’ in the context of the present application shall therefore cover any suitable process for physical or chemical modification of the still hot inner surface of the glass tube during hot forming.

The substance may also be introduced or dumped in the form of a mixture comprising a plurality of substances which contribute to the internal coating of the glass tube on the basis of various processes.

According to a further embodiment of the present invention, the dispersion is introduced or dumped into the softened glass bag at a predetermined excess pressure. The relatively high flow rate of the aerosol, of the suspension or of the emulsion thereby achievable makes it possible, for example, for the respective substance to be rapidly introduced or dumped into the region of hot forming, that is at a temperature below the critical temperature above which the substance undergoes thermal decomposition, reacts, precipitates or the like.

With the selected excess pressure, a parameter is available that is easy to control or regulate and has an influence on the quantity of aerosol introduced into the hot forming region. By this means, the level of internal coating of the glass tube can be controlled or regulated by varying the excess pressure. This control can be undertaken electronically or by an operator, based, for example, on determining the coating parameters, such as homogeneity, degree of coverage, chemical composition and/or thickness. This investigation of the coating can essentially also be undertaken with an already cooled glass tube, in particular a sample glass tube from a batch. According to a further embodiment, the coating can also be investigated during an ongoing manufacturing process and serve as the basis of a continuous regulation of the coating process.

Suitable control or regulation of the coating process can of course be achieved by suitable selection of the concentration of the substance in the aerosol by means of suitable control or regulation of a dosing device for dosing the substance.

According to a further embodiment, an aerosol is formed in a process gas which is blown into the bag of softened glass. This process gas may be, in particular, CO₂, noble gases or mixtures thereof, to which oxygen can also be added in a suitable concentration. However, the process gas can in principle also have a larger oxygen content compared to the atmosphere, even to the extent of being pure oxygen, which can be advantageous for the further reaction of the aerosol particles in the hot forming process.

According to a further embodiment, an aerosol is introduced through an outlet opening at the front end of a forming body, over which the glass melt is drawn. For this purpose, the forming body suitably has an axial inner bore so that the aforementioned outlet opening can communicate with an inlet for the aerosol. This inlet can be provided in a relatively cool region of the device, which enables use of simple hose or line connections for feeding in the aerosol.

According to a further embodiment, the solid or liquid particles in the aerosol, suspension or emulsion have an average diameter of less than approximately 5 μm. The resulting large surface area of the aerosol enables, for example, rapid and complete reaction of the particles for internal coating. Still faster and more complete reaction of the particles is achieved if the average diameter of the aerosol particles is less than approximately 3 μm. A yet more complete and rapid reaction of the particles is achieved with an average particle diameter of less than approximately 1 μM.

According to a further embodiment of the present invention, the introduced substance undergoes thermal decomposition during hot forming of the glass tube. By this means, a substance can be made available during the hot forming process which is suitable for internal coating by physical or chemical modification of the inner surface.

According to a further embodiment, an aerosol is formed from extremely finely ground or nanoscale organometallic compounds. The relevant metal can be chosen from a group including all metals with the exception of the alkali metals. The organometallic compound may for example be a citrate, tartrate, lactate, etc.

Suitable metals that are preferable for the metal compounds are Si, Al, Zr and Ti, whereby Si and Al are further preferred and Si is particularly preferred. Also conceivable are mixtures of two or more metal compounds including at least two different metals, whereby mixtures containing at least one organic silicon compound are preferable. Particularly suitable are mixtures containing tetraethoxysilane as one component. Also conceivable with regard to mixtures, however, are all combinations of suitable compounds, particularly those which include compounds containing the preferred metals given above. Organic constituents of the organometallic compounds which come into consideration are groups “R” which have 1 to 10 carbon atoms. These may be straight chains (unbranched), branched or cyclic. The groups can also contain oxygen atoms, whereby according to a preferred embodiment, the oxygen atom is bound to the metal atom. Examples of particularly preferred groups which are bound by the oxygen atom to the metal atom are methoxy, ethoxy, propoxy and butoxy. For groups with 3 and more carbon atoms, the carbon content may be present in any branch, that is, in the unbranched (n-form), in the iso-form, or in the secondary or tertiary form. Also suitable are acyloxy-groups, such as acetyloxy or propionyloxy. Also available are groups R containing alkylcarbonyl, alkyldicarbonyl and alkoxycarbonyl groups. Particularly preferable are compounds containing silicon as the metal and an R group selected from methoxy, ethoxy, propoxy, butoxy, acetyloxy, propionyloxy, alkylcarbonyl, alkyldicarbonyl or alkoxycarbonyl. According to one embodiment, the organometallic compound belongs to the group of tetraalkoxysilanes. Particularly preferable is the compound tetraethoxysilane.

According to a further embodiment, the aerosol is formed from a finely ground or nanoscale metal oxide. The metal oxide may be chosen from a group including SiO₂, Al₂O₃, ZrO₂, TiO₂. Silicon oxide and aluminium oxide are particularly preferable, and silicon oxide is most preferable.

According to a further embodiment, an emulsion or suspension of a liquid, oxygen-containing, organometallic compound is formed. The organometallic compound may include a metal selected from among the elements Si, Al, Zr and Ti, whereby Si and Al are preferable and Si is particularly preferable. Also conceivable are mixtures of two or more metal compounds comprising at least two different metals, whereby mixtures containing at least one organic silicon compound are preferable. Reference should be made to the above for suitable oxygen-containing R groups.

A further aspect of the present invention concerns the use of an internally coated glass tube manufactured according to the aforementioned method for further processing into a hollow internally coated formed glass body, for example an internally coated glass container for pharmaceutical applications or an illuminant, such as a fluorescent lamp for back-lighting LCD displays, a flash discharge lamp or a halogen incandescent lamp (since an SiO₂ layer can act as a blocking layer against Na ions in the glass). Naturally, glass tubes made in this way can also be used for chemical plant design, for flow meters for chemically aggressive media, for analytical purposes (for example burette tubes, titration cylinders, etc.), for test tubes for special purposes, for jackets for measuring electrodes in aggressive media, as discharge lamps, as components for biotechnical reactors and as containers for medical purposes (for example, ampoules, small bottles, syringe bodies, cylindrical ampoules, etc.).

Preferably, the method according to the invention is used for internal coating of glass tubes made of low melting point glass, such as borosilicate glass or soda-lime glass. Advantageously, these tubes can be economically manufactured and shaped. Examples of these types of glass are: Duran® borosilicate glass (Schott), Fiolax® Klar (Schott), Fiolax® Brown (Schott) and Kimbel N51A (Kimbel). Naturally, the method according to the invention can also be used for glass tubes made of high melting point glass, such as quartz glass.

A further aspect of the present invention relates to the provision of a device for manufacturing an internally coated glass tube for use with the above method. A device of this type has a forming body over which the glass melt is drawn to form the bag of softened glass, whereby at the front end of the forming body an outlet opening for introducing or dumping a substance into the bag of softened glass is formed. According to the invention, the device comprises an aerosol generating device for producing an aerosol, as described above, wherein the aerosol generating device communicates with the outlet opening, so that the substance can be introduced or dumped as an aerosol into the bag of softened glass.

### DRAWINGS

The invention will now be described in greater detail and in exemplary manner by reference to the accompanying drawings, disclosing further features, advantages and objects, and wherein:

FIG. 1 shows, in a schematic sectional view, a device for a method according to a first embodiment of the present invention;

FIG. 2 shows, in two schematic sectional views, a device for carrying out a method according to a second embodiment of the present invention; and

FIG. 3 shows, in a schematic block diagram, an arrangement for generating an aerosol according to the present invention.

Throughout the drawings, identical reference numerals refer to identical elements or element groups or such as have substantially the same technical effect.

### DETAILED DESCRIPTION OF PREFERRED EXEMPLARY EMBODIMENTS

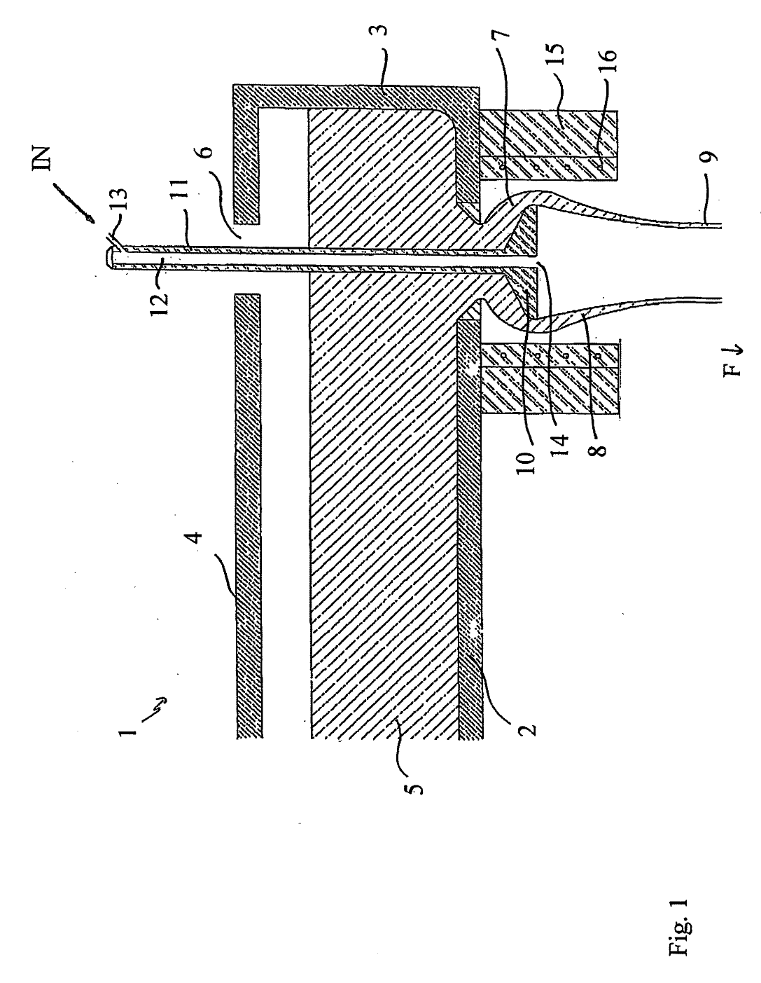

As FIG. 1 shows, the drawing device, identified as a whole with the number 1, comprises a melt feed having a base 2, a side wall 3 and an upper cover 4, in order to feed suitably conditioned melt glass 5 contained therein. Formed in the base 2 is an outlet opening delimited by an outflow ring, through which outlet opening the glass melt emerges. Disposed beneath the outlet opening is a forming body 10 configured as a drawing needle which, together with the outlet opening, forms an annular gap which controls the quantity of melt emerging. As indicated by the arrow F, the emerging glass melt 7 is drawn over the forming body 10. Downstream of the forming body 10, a hose-like formation made of softened glass, also referred to as a drawing bulb, is formed. In this hot forming region, the softened glass is still mouldable or deformable, that is, the temperature of the softened glass lies above the softening temperature of the respective glass type. According to FIG. 1, in the hot forming region, the glass melt is converted by a free forming process into the glass tube 9, which is drawn off. In this glass drawing process according to the known Vello method, the inner profile of the glass tube 9 is predetermined by the profile of the forming body 10 and the conditions in the hot forming region, and the wall thickness of the glass tube 9 is determined particularly by the annular gap, the temperature of the glass melt 5 and the drawing rate.

According to FIG. 1, the shaft 11 serving to fix the forming body 10 has an axial internal bore 12 which gives way via the outlet opening 14 to the hot forming region in the interior of the bag 8 made of softened glass. According to FIG. 1, the shaft 11 extends through the melt 5 and an opening 6 in the upper cover 4, although other arrangements can also be provided. The forming body 10 and the shaft 11 are formed from a suitable refractory material that can be coated with a heat-resistant and suitably unreactive metal, such as platinum or a platinum alloy. According to FIG. 1, at the upper end of the shaft 11 an inlet 13 is formed, through which the process gas can be blown into the hot forming region via the axial inner bore 12. According to the invention, a suitable aerosol is also introduced or dumped through the inlet 13 into the hot forming region, in order to bring about internal coating of the bag 8 of softened glass and of the interior of the tube 9, as will now be described.

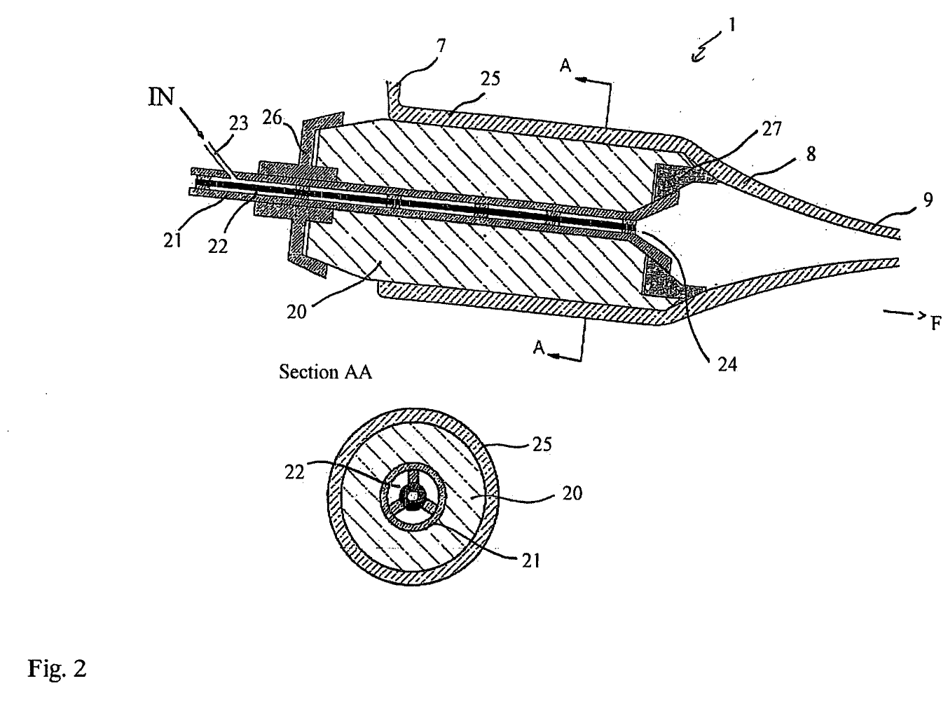

FIG. 2 shows a device for drawing an internally coated glass tube by the Danner method according to the present invention. In FIG. 2, the emerging glass melt 7 reaches the exterior peripheral surface of a rotating cylinder 20 made of refractory material, which can be covered with a metal, as described above. Due to the rotation of the cylinder 20, a cylindrical jacket 25 of even thickness forms from the glass melt on the exterior periphery of the cylinder 20, and said jacket is drawn off to the right in FIG. 2, as indicated by the arrow F. Therefore, in the manner described above, a bag 8 of heated glass forms at the front end of the cylinder 20 and this in turn is transformed by hot forming into the glass tube 9. According to FIG. 2, the rear bearing 26 and the front bearing 27 lie on the concentric drive shaft 21, which has an axial inner bore 22 which opens via the outlet 24 into the hot forming region. According to FIG. 2, the inner bore 22 has an inlet 23 on a relatively cool section of the drive shaft 21 for the entry of process gas and aerosol, which are blown into the hot forming region.

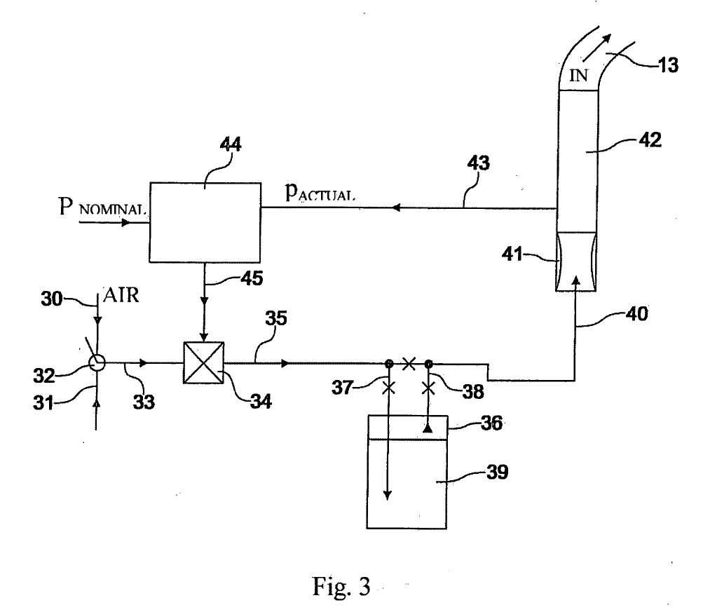

FIG. 3 shows a section for producing an aerosol according to the present invention. According to FIG. 3, with the aid of the mixing valve 32, ambient air from the air line 30 and/or process gas, for example, nitrogen, CO₂, noble gas, possibly mixed with oxygen is let into the line 33, whereby the pressure or the flow rate in the line 35 is adjusted with the aid of the regulating valve 34. The pressure control or regulating means 44 serves to control or regulate the pressure by controlling the regulating valve 34 via the signal line 45. According to FIG. 3, part of the gas in the line 35 is let via the line 37 into a container 36, which stores a substance for internal coating of the glass tube. This substance may be a finely ground powder or a liquid. For further conditioning of the liquid, the container 36 may suitably be heated in order to adjust the vapour pressure and the temperature of the liquid 39. By means of the line 38, the liquid or powdered substance is fed into the line 40, which finally gives way to an injector or injecting device 41 for generating the aerosol. The aerosol is introduced or dumped via the line 42 into the inlet of the aforementioned drawing device. The actual pressure in the connecting line 42 can be measured and passed via the signal line 43 to the pressure control or regulating means 44. As a result, by this means an aerosol is formed by dispersion of liquid or solid particles in a process gas or another suitable gas which is introduced or blown into the hot forming region via the axial inner bore of the forming body of the drawing device. The parameters for the injecting device 41 can be selected so that the particles of the aerosol have a mean diameter of less than approximately 5 μm, preferably less than approximately 3 μm and yet more preferably, less than approximately 1 μm. The aerosol is introduced into the hot forming region at a temperature of below approximately 200° C., that is, below a temperature at which the reactive substance in the aerosol undergoes thermal decomposition. The reaction and/or deposition of the reactive substance for internal coating therefore preferably comes into contact with the hot glass surface in the region of the bag 8 of softened glass.

### Exemplary Embodiment 1

In this exemplary embodiment, a glass tube made of Fiolax was internally coated. The tube was drawn at a drawing speed of 0.733 metres per second and a throughput rate of 670 kg per hour to an outer diameter of 30.0 mm and a wall thickness of 1.20 mm. The cutting length of the glass tubes was 158 cm. The hydrolytic resistance was ascertained with a test to RS-TA 2010, as described below. Furthermore, the internal coating of the glass tube was tested by means of SIMS analysis (secondary ion mass spectroscopy) to a depth of approximately 160 nm. There was no substantial change in the glass composition. The layer thicknesses achieved were in the range of 50 nm to 100 nm.

The aerosols were formed from finely ground or nanoscale powders of organometallic compounds or metal oxides. Any metals could be used with the exception of the alkali metals. The organometallic compounds included, in particular, the citrates, tartrates and lactates. The metal oxides that were investigated were SiO₂, Al₂O₃, ZrO₂ and TiO₂. The table below gives the results obtained for various powders used. Improvements in the hydrolytic resistance of the glass of up to 20% were obtained using the RS-TA 2010 test, as described below.

| | Blowing | Powder | | Batch | M value Na₂O |
|---|---|---|---|---|---|
| Powder | medium | consumption, g | Notes | No. | output mg/l |
| | Air | | Conversion to tube geometry | 0 | 0.32 |
| | | | and installation of the dosing | | |
| | | | system; determination of a | | |
| | | | reference value | | |
| Al-acetotartrate | Air | 49 | Change of blowing medium | 5 | 0.28 |
| Al-lactate | Air | | | 7 | |
| Al-lactate | N₂ | 20 | Change of blowing medium | 8 | 0.27 |
| Aerosil SiO₂ | N₂ | | | 10 | 0.25 |
| Aerosil SiO₂ | Air | 16 | Change of blowing medium | 11 | 0.28 |

The method used for the aforementioned RS-TA-2010 testing procedure for determining the hydrolytic resistance, in particular the release of Na₂O to water, from the internal coating of glass tubes will now be described in greater detail.

This procedure is based on a DIN 52 329 testing procedure. It is an autoclave process for determining the water resistance of the inner surface of glass vessels (see also DIN 52 329, DIN 52, 339-2, ISO 4502-2, DAB, Ph. Eur.). A high pressure steam autoclave designed for a pressure of 2.5×10⁵ N/m² is used, which allows the test condition of 121±1° C. to be maintained. A blowlamp, model Arnold (table-top burner), with additional oxygen connection was used, a dispenser or burette for filling the container, aluminium foil for covering the tube under test in the autoclave, and an atomic absorption spectrometer (FAAS) or atomic emission spectrometer (FAES) were also used.

The following are used as reagents: for washing water, simply distilled or deionised water; for top-up water, double distilled water which had been largely freed from carbon dioxide and dissolved gases by boiling in vessels made of glass belonging to the hydrolytic resistance class ISO 719-HGB 1. The water must be neutral to methyl red when tested immediately before use, i.e. it must produce an orange-red colouration (not violet or yellow), corresponding to a pH value of 5.5±0.1 when 2 drops of methyl red indicator solution are added to 25 ml of the water; as the methyl red indicator solution, 25 mg of the sodium salt of methyl red which has been dissolved in 100 ml double distilled water was used; as the Na₂O stock solution, 1000 mg Na₂O/l (corresponds to 1 mg Na₂O/ml), which has been made from sodium chloride dried for 2 hours at 110° C. and top-up water; as the Na₂O standard solutions, calibration solutions for spectrometers were used, made from the stock solution and top-up water with the following concentrations: 0.5-1.0-1.5-2.0-2.5-3.0-4.0-5.0 mg Na₂O/l; as the K₂O stock solution, 1000 mg K₂O/l (corresponds to 1 mg K₂O/ml), which has been made from potassium chloride dried at 110° C. for 2 hours and top-up water; as K₂O standard solutions, calibration solutions for spectrometers were used, made from the stock solution and top-up water with the following concentrations: 0.5-1.0-1.5-2.0-2.5-3.0-4.0-5.0 mg K₂O/l.

Sample preparation: Testing was carried out using four tubes in each case.

a) With tubes closed at each end, a 360 mm long section was separated from the end, containing no pressure equalisation opening. The tube end was again cut off at a distance of 120 mm from the base. The tube sections with the bases were thrown away.

b) With tubes open at each end, again a 360 mm long section was separated, the tube end was cut off at a distance of 120 mm and thrown away.

The 240 mm long sections were heated in the centre while rotating over the blowtorch or table-top burner until the ductile stage, and pulled apart. The resulting eight pieces of 120 mm length each were heated at the end with the capillary until drop formation, while turning. The drop itself was carefully pulled off with hot glass. The test tube base was melted into a round shape by brief blowing by mouth.

The test was carried out as follows.

Rinsing and filling of the vessels: the vessels were thoroughly rinsed twice with washing water and, immediately before filling for autoclaving, rinsed once with top-up water. After rinsing, the vessels were filled with top-up water using the filling volumes (corresponding to ca. 20 mm below the opening) given in Table 1 and covered with aluminium foil.

TABLE 1
Determination of the filling volume and limit values for NaO₂ release

| | | Limit | | | Limit | | | Limit |
|---|---|---|---|---|---|---|---|---|
| Internal | Filling | values | Internal | Filling | Value | Internal | Filling | Value |
| diameter, | volume, | in | diameter, | volume, | in mg | diameter, | volume, | in mg |
| mm | ml | NaO₂/l | mm | ml | NaO₂/l | mm | ml | NaO₂/l |
| 5.3 | 2.0 | 1.10 | 13.0 | 12.0 | 0.50 | 26.1 | 48.0 | 0.40 |
| 5.6 | 2.2 | 1.00 | 13.6 | 13.0 | 0.50 | 26.6 | 50.0 | 0.40 |
| 5.8 | 2.4 | 1.00 | 14.1 | 14.0 | 0.50 | 27.1 | 52.0 | 0.30 |
| 6.1 | 2.6 | 1.00 | 14.6 | 15.0 | 0.50 | 27.6 | 54.0 | 0.30 |
| 6.3 | 2.8 | 1.00 | 15.0 | 16.0 | 0.50 | 28.1 | 56.0 | 0.30 |
| 6.5 | 3.0 | 1.00 | 15.5 | 17.0 | 0.50 | 28.6 | 58.0 | 0.30 |
| 6.7 | 3.2 | 0.80 | 16.0 | 18.0 | 0.50 | 29.1 | 60.0 | 0.30 |
| 6.9 | 3.4 | 0.80 | 16.4 | 19.0 | 0.50 | 30.1 | 64.0 | 0.30 |
| 7.1 | 3.6 | 0.80 | 16.8 | 20.0 | 0.50 | 31.0 | 68.0 | 0.30 |
| 7.3 | 3.8 | 0.80 | 17.6 | 22.0 | 0.40 | 31.9 | 72.0 | 0.30 |
| 7.5 | 4.0 | 0.80 | 18.4 | 24.0 | 0.40 | 32.8 | 76.0 | 0.30 |
| 7.7 | 4.2 | 0.80 | 19.2 | 26.0 | 0.40 | 33.6 | 80.0 | 0.30 |
| 7.9 | 4.4 | 0.80 | 19.9 | 28.0 | 0.40 | 34.5 | 84.0 | 0.30 |
| 8.1 | 4.6 | 0.80 | 20.6 | 30.0 | 0.46 | 35.3 | 68.0 | 0.30 |
| 8.2 | 4.8 | 0.80 | 21.3 | 32.0 | 0.40 | 36.1 | 92.0 | 0.30 |
| 8.4 | 5.0 | 0.80 | 21.9 | 34.0 | 0.40 | 36.9 | 96.0 | 0.30 |
| 9.2 | 6.0 | 0.65 | 22.6 | 36.0 | 0.40 | 37.6 | 100 | 0.30 |
| 10.0 | 7.0 | 0.65 | 23.2 | 38.0 | 0.40 | 39.4 | 110 | 0.25 |
| 10.6 | 8.0 | 0.65 | 23.8 | 40.0 | 0.40 | 41.2 | 120 | 0.25 |
| 11.3 | 9.0 | 0.65 | 24.4 | 42.0 | 0.40 | 42.9 | 130 | 0.25 |
| 11.9 | 10.0 | 0.65 | 24.9 | 44.0 | 0.40 | 44.5 | 140 | 0.25 |
| 12.5 | 11.0 | 0.50 | 25.5 | 46.0 | 0.40 | 46.1 | 150 | 0.25 |

Autoclave heating: the prepared and filled vessels were placed, in the rack provided, into the autoclave filled with the necessary quantity of distilled water. After closing of the autoclave, heating was commenced with the ventilating valve open until a lively flow of steam was blowing off. This steam flow was allowed to continue for 10 minutes, after which the valve was closed and the temperature increased at a rate of 1° C./min to 121° C. This condition was maintained for 30±1 min to ±1° C. Following this test period, the temperature was reduced at a rate of 1° C./min to 100° C. After ventilation, the hot samples were removed from the autoclave and cooled to room temperature within 30 minutes.

Flame photometry measurement: the content of the individual cooled vessels was sprayed directly (i.e. without decanting or cleaning) into the flame of the FAAS or FAES. The concentrations of Na₂O and K₂O were determined on the basis of previously recorded Na₂O and K₂O calibration curves. It should be noted that the measurement series was maintained so that, for each vessel, for each measured Na₂O value, the corresponding K₂O value can be documented.

For measured values <0.10 mg K₂O/l, the results were ignored for the evaluation. Evaluation: the measured values for tube and base were evaluated separately, the respective mean value was calculated and then entered in the relevant test report. For a release to be issued, the measured value had to fall below the limit value given in Table 1.

Where the value exceeded the limit value, testing of the tube was repeated, possibly at a later time point.

Limit values: the limit values used in the above procedure corresponded approximately to the concentration of the limit values to DIN 52339-2 and ISO 4802-2 for glasses of the water resistance class ISO 719 HGB 1.

What is claimed is:

1. A method for manufacturing a glass tube having a coated inner surface comprising the steps of
drawing a glass melt (5) to a bag (8) of softened glass and
hot forming said bag of softened glass to a glass tube (9), in which method
a substance is introduced into the bag (8) of softened glass,
wherein the substance is introduced as an aerosol and the inner surface is coated by means of the substance during the hot forming.

2. The method according to claim 1, wherein the aerosol is introduced into the bag (8) of softened glass at a predetermined excess pressure, which can be controlled or regulated for affecting the coating of the inner surface of the glass tube (9).

3. The method according to claim 1, wherein the aerosol is formed by dispersion of liquid or solid particles in a process gas which is blown into the bag (8) of softened glass.

4. The method according to claim 3, wherein the particles have a mean diameter of less than 5 μm, preferably less than 3 μm and most preferably less than 1 μM.

5. The method according to claim 1, wherein the substance undergoes thermal decomposition during hot forming of the glass tube (9).

6. The method according to claim 1, wherein the aerosol is formed from finely ground or nanoscale organometallic compounds.

7. The method according to claim 6, wherein the metal is selected from among Si, Al, Zr and Ti.

8. The method according to claim 7, wherein the organometallic compound is a compound comprising
a metal atom selected from among Si, Al, Zr and Ti, and also
a group R, wherein R stands for a possibly oxygen-containing, branched or unbranched carbon group with 1 to 10 carbon atoms.

9. The method according to claim 1, wherein the aerosol is formed from a finely ground or nanoscale metal oxide.

10. The method according to claim 9, wherein the metal oxide is selected from a group including SiO₂, Al₂O₃, ZrO₂, TiO₂.

11. The method according to claim 1, wherein the aerosol is formed from a liquid, oxygen-containing, organometallic compound.

12. The method according to claim 11, wherein the metal is selected from among Si, Al, Zr and Ti.

13. The method according to claim 12, wherein the organometallic compound is selected from among a metal alcoholate, a metal acyloxy compound or a metal alkylcarbonyl compound.

14. The method according to claim 1, wherein the hydrolytic resistance of the coated inner surface or the release from the coated inner surface of sodium ions to water is improved or reduced, compared with an untreated inner surface, by at least 10%, preferably by at least 15%, and still more preferably by at least 20%.

15. Use of an internally coated glass tube (9) manufactured by the method according to, for further processing to a hollow internally coated formed glass body.

16. The use according to claim 15, wherein the internally coated glass tube (9) is further processed to an illuminant, in particular fluorescent lamps for back-lighting LCD displays, flash discharge lamps or halogen incandescent lamps, or to glass containers, particularly primary packaging means for pharmaceutical applications.

17. An apparatus for manufacturing a glass tube having a coated internal surface by drawing a glass melt (5) to a bag (8) of softened glass and hot forming to a glass tube (9), said apparatus comprising:
a forming body (10, 20), over which the glass melt (5, 7) is drawn to the bag (8) of softened glass,
an outlet opening (14, 24) being formed at the front end of the forming body (10, 20) for introducing a substance into the bag (8) of softened glass,
said apparatus further comprising:
an aerosol generating device (41) for generating an aerosol which comprises the substance, said aerosol generating device (41) communicating with the outlet opening (14, 24), so that the substance can be introduced into the bag (8) made of softened glass as an aerosol, in order to effect the coating of the inner surface by means of the substance during the hot forming.

18. The apparatus according to claim 17, wherein the aerosol is fed via an axial inner bore (12, 22) of the forming body (10, 20) to the outlet opening.

19. The apparatus according to claim 17, further comprising a pressure controlling or regulating means (44) in order to introduce the aerosol into the bag (8) of softened glass at a predetermined excess pressure, which is controllable or regulable to influence the coating of the inner surface of the glass tube (9).

20. The apparatus according to claim 19, wherein the pressure is controllable or regulable such that the aerosol can be introduced at the outlet opening (14, 24) into the bag (8) of softened glass at a temperature below a temperature at which the substance undergoes thermal decomposition.
